(19) United States
(12) Patent Application Publication
(10) Pub. No.: US 2005/0088939 A1
(43) Pub. Date: Apr. 28, 2005

(54) Method of recording data on information storage medium using multi-session, information storage medium drive, and information storage medium therefor

(75) Inventors: Sung-hee Hwang, Seoul (KR); Jung-wan Ko, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/941,085

(22) Filed: Sep. 15, 2004

(30) Foreign Application Priority Data
Sep. 17, 2003 (KR) 2003-64587

(51) Int. Cl. G11B 5/09

(52) U.S. Cl. 369/53.21; 369/47.21; 369/59.25

(57) ABSTRACT

A method to record data using multi-sessions, and an information storage medium therefor, by which a data area arranged on an information storage medium is divided into a plurality of sessions and data is recorded, includes: recording session status information indicating a session in which recording data is permitted, among the plurality of sessions; and recording data in the session in which recording data is permitted, according to the session status information. When data is recorded on an information storage medium by using this multi-session method, a data recording area may be used more efficiently.

### CROSS-REFERENCE TO RELATED APPLICATIONS

This application claims the priority of Korean Patent Application No. 2003-64587, filed on Sep. 17, 2003, in the Korean Intellectual Property Office, the disclosure of which is incorporated herein in its entirety by reference.

### BACKGROUND OF THE INVENTION

1. Field of the Invention

The present invention relates to a method of recording data on an information storage medium by using a multi-session method, and a drive and an information storage medium therefor.

2. Description of the Related Art

In conventional technologies, when user data is recorded on a write-once disc, a data area arranged on the write-once disc is divided into one or more sessions, each of the sessions is again divided into a plurality of sub data areas, and then, data is recorded. The method of recording data on a medium in this manner is referred to as a multi-session method. The statuses of respective sessions may be divided into two types. The first status is a closed status in which additional data recording is prohibited, and the second status is an open status in which additional data recording is permitted.

However, when data is recorded on a medium according to the conventional session method, there are numerous restrictions in using the medium. For example, when a file system including a variety of information items on data recorded on a write-once information storage medium is recorded on the medium, a problem may occur.

For a file system, a predetermined area of a user data area on a medium, for example, a predetermined interval of the front part of a user data area, is usually preselected. In the same manner, also in a write-once information storage medium, a partial area of the front part of a user data area is selected as a reserved area, and user data is recorded in an area other than the reserved area.

Then, when data cannot be recorded on the medium any more, or when the medium is finalized by selection of a user to prevent additional data recording, a final file system is recorded in the reserved area.

However, when data is recorded on a write-once recording medium according to the conventional multi-session method, when the medium is finalized, if a session belongs to a reserved area in which the final file system is to be recorded, wherein the reserved area has a closed status, the final file system cannot be recorded.

### SUMMARY OF THE INVENTION

The present invention provides a data recording method by which, when data is recorded on an information storage medium by using a multi-session method, a data recording area may be used more efficiently, and a drive and an information storage medium therefor.

According to an aspect of the present invention, data is recorded using a multi-session method, by which a data area arranged on an information storage medium is divided into a plurality of sessions and data is recorded, the data recording method including: recording session status information indicating a session in which recording data is permitted, among the plurality of sessions; and recording data in a session in which recording data is permitted, according to the session status information.

According to another aspect of the present invention, data is recorded on an information storage medium according to a multi-session method by which a data area is divided into a plurality of sessions and data is recorded, wherein: information recorded thereon indicates the location of each of the sessions; and session status information recorded thereon indicates a session in which recording data is permitted, among the plurality of sessions.

According to still another aspect of the present invention, a drive apparatus of an information storage medium in which a data area is divided into a plurality of sessions and data is recorded, includes: a recording and/or reading unit which records data on or reads recorded data from the information storage medium; and a control unit which controls the recording and/or reading unit such that session status information indicating a session in which recording data is permitted, among the plurality of sessions is recorded on the information storage medium, and data is recorded in a session in which recording data is permitted, according to the session status information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are diagrams illustrating a structure of a write-once disc according to an embodiment of the present invention;

FIG. 2 is a diagram illustrating the structure of a recording layer of a single-recording-layer write-once disc or a first recording layer of a double-recording-layer write-once disc in accordance with an embodiment of the present invention;

FIG. 3 is a diagram illustrating a structure of a second layer of a double-recording-layer write-once disc in accordance with an embodiment of the present invention;

FIG. 4 is a diagram illustrating an embodiment of a data structure of a record map according to an embodiment of the present invention;

FIG. 5 is a diagram illustrating an embodiment of a structure of a record map entry according to an embodiment of the present invention;

FIG. 6 is a diagram illustrating an example of session status information of a record map entry according to an embodiment of the present invention;

FIG. 7 is a diagram illustrating an example of a data area which is divided into a plurality of sub data areas and sessions in accordance with an embodiment of the present invention;

FIG. 8 is a flowchart of operations performed by a data recording method using a multi-session method according to an embodiment of the present invention; and

FIG. 9 is a block diagram of an information storage medium drive according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

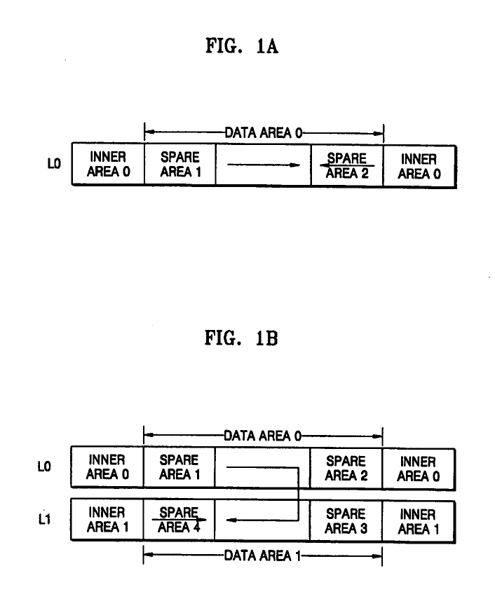

FIGS. 1A and 1B are diagrams illustrating a structure of a write-once disc according to an embodiment of the present invention. FIG. 1A shows a single-recording-layer write-once disc, and FIG. 1B illustrates a double-recording-layer write-once disc. In each data area, spare areas are arranged to be used to record data recorded in a user data area when a defect occurs in the user data area. Arrows shown in the data areas in FIGS. 1A and 1B indicate the directions of using the user data areas.

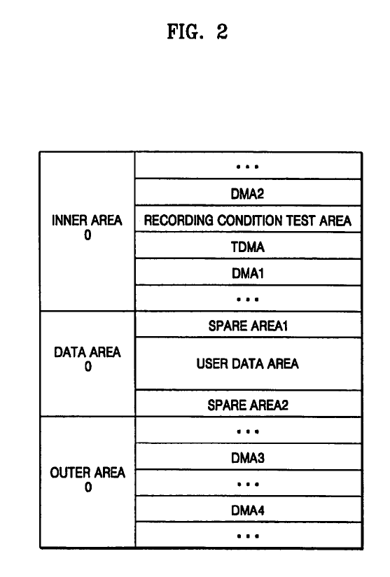

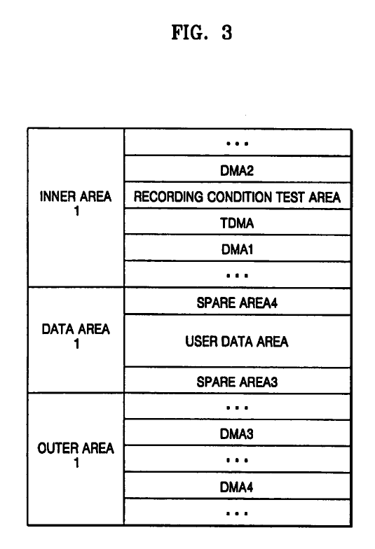

FIG. 2 is a diagram illustrating a structure of a recording layer of a single-recording-layer write-once disc or a first recording layer (L0) of a double-recording-layer write-once disc in accordance with an embodiment of the present invention, and FIG. 3 is a diagram illustrating a structure of a second layer (L1) of a double-recording-layer write-once disc in accordance with the present invention.

The recording layer of the single-recording-layer write once disc or each recording layer of the double-recording-layer write once disc includes an inner area, a data area, and an outer area.

In each of the inner areas, a plurality of disc management areas (DMAs) that are defect management areas, a recording condition test area, and a temporary disc management area (TDMA) are arranged. In each data area, a plurality of spare areas and a user data area are arranged, and a plurality of DMAs are additionally prepared as defect management areas in each outer area.

The TDMA is not present in a rewritable medium, but, in the case of a write-once disc, is allocated separately, based on the characteristic of the medium.

In the TDMA, temporary disc management structure information (TDMS) is recorded. The TDMS includes information to manage, temporarily, a defect that occurs when a write-once disc is used, and information to manage, temporarily, a disc, such as a record map indicating a recording status of a data area. Information on temporary defect management includes a temporary disc definition list (TDDS) and a temporary disc definition structure (TDDS). The TDFL is information indicating the location where a defect occurs and the location of a replacement spare area. The TDDS includes information on the location where the TDFL is recorded, and in addition, also includes information on the location and size of a spare area allocated when the disc is initialized, write prevention information, information on the location and size of the TDMA allocated to a data area, the last recorded address (LRA) of the user data area, and the like.

The TDMA may also be allocated to a data area when initialization to use the medium is performed, according to selection of a drive manufacturer or a user. When the medium is initialized according to selection of a drive manufacturer or a user, whether spare areas are allocated to a data area and the size of the spare areas are determined.

When a write-once disc is finalized, final disc defect information and other information recorded in a TDMA are copied into a DMA, considering problems such as compatibility with other media.

Meanwhile, the TDDS includes a record map that is information indicating the data recording status of a data area. The record map includes head information and a plurality of record map entries. Each record map entry indicates the data recording status of one sub data area among the plurality of sub data areas included in the data area.

In the present invention, when data is recorded on an information storage medium by using a multi-session method, session status information indicating whether each session is in a closed status, in which data recording is prohibited, or in an open status, in which recording data is permitted, is recorded on the medium such that each session may be used efficiently. In the present invention, the following two embodiments are provided as methods to record session status information on a medium.

In the first embodiment, the number of a predetermined location, for example, the first or the last sub data area, among a plurality of sub data areas included in each of the sessions in an open status in which recording data is permitted, is recorded in the header of a record map.

In the second embodiment, session status information is included and recorded in a record map entry corresponding to a predetermined location, for example, the first or the last sub data area, among a plurality of sub data areas included in each of the sessions in an open status in which recording data is permitted.

The first of the two embodiments will be explained below in more detail.

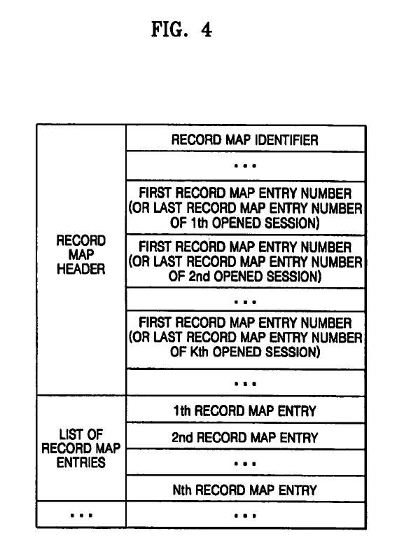

FIG. 4 is a diagram illustrating an embodiment of the data structure of a record map according to the present invention. Referring to FIG. 4, a record map includes a record map header and a plurality of record map entries.

In the record map shown in FIG. 4, a total of N record map entries are recorded. N record map entries recorded in one record map indicates that a data area arranged in an information storage medium is divided into N sub data areas for use.

In the record map head, the identifier of the record map and the number of the first (or last) sub data area of each of k sessions in an open status, in which recording data is permitted, are recorded.

If the boundary of each session is not known, or if it is desired that a drive may quickly access an area specified by each session, the numbers of the first and last sub data areas of a session in an open status are generally recorded together to show the boundary of the session.

Next, the second embodiment to record session status information on a medium will be explained in more detail.

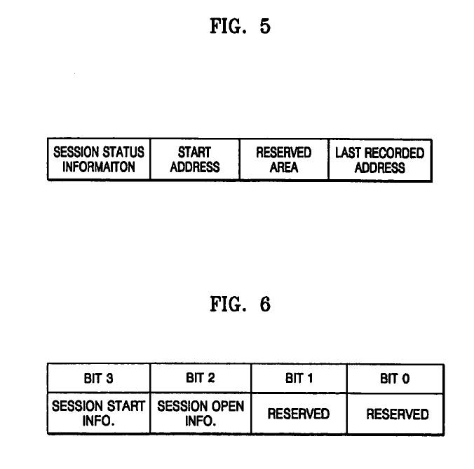

FIG. 5 is a diagram illustrating an embodiment of the structure of a record map entry according to the present invention. Referring to FIG. 5, the record map entry includes session status information, a start address of a sub data area indicated by the record map entry, and a last recorded address (LRA) in which user data is recorded last.

The session status information may be recorded in all record map entries corresponding to a plurality of sub data areas included in sessions in an open status. However, in terms of recording and reproducing session status information, it is more efficient to record session status information only in the status information area of record map entry corresponding to the first or last sub data area included in the session in an open status.

FIG. 6 is a diagram illustrating an example of session status information of a record map entry according to an embodiment of the present invention. The example shown in FIG. 6 is a case wherein session status information is recorded in the status information area of a record map entry corresponding to the first sub data area included in a session in an open status.

Referring to FIG. 6, session status information bit 3 is information indicating whether a record map entry is the first entry of a plurality of record map entries corresponding to sub data areas belonging to the corresponding session. For example, if the value of bit 3 is ‘0’, it indicates that the entry is not the first one, and if the value is ‘1’, it indicates that the entry is the first entry.

Bit 2 is information indicating whether the corresponding session is in an open status or a closed status. For example, if the value of bit2 is ‘0’, it indicates that the corresponding session is in an open status, and if the value is ‘1’, it indicates that the corresponding session is in a closed status.

Finally, bit 0 and bit 1 are information areas reserved for session status information to be added later.

The record map entry according to the embodiment shown in FIG. 5 is formed with 64 bits. The session status information is assigned 4 bits, the start address and the LRA are assigned 28 bits each, and the reserved area is assigned 4 bits. The reserved area has recording status information of a sub data area indicated by the record map entry, for example, information indicating whether the sub data area is in an open status in which recording is permitted, or in a closed status in which recording is prohibited, or whether a damaged area which is generated by the occurrence of an abnormal situation, such as power-down while user data is recorded in the sub data area, is in the sub data area.

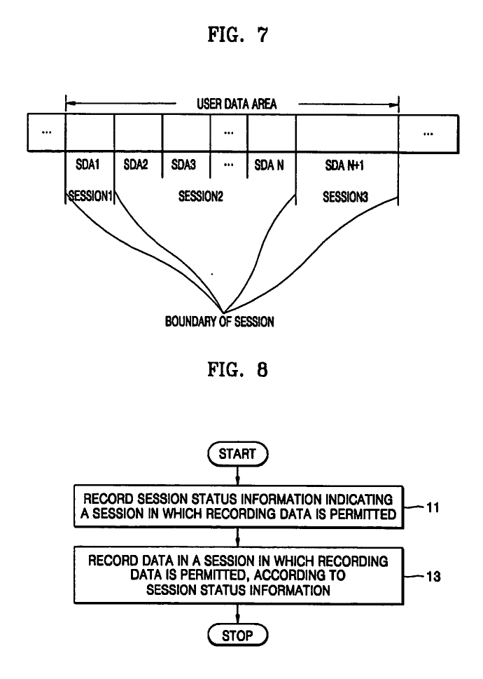

FIG. 7 is a diagram illustrating an example of a data area which is divided into a plurality of sub data areas and sessions. Referring to FIG. 7, a data area is divided into three sessions, session 1 through 3. Session 1 includes one sub data area, sub data area 1 (SDA1), session 2 includes N−1 sub data areas, SDA 2 through SDA N, and session 3 includes one sub data area, SDA N+1.

Among the sessions shown in FIG. 7, only session 2 is in an open status, and the remaining sessions are in a closed status, according to the first embodiment for recording session status information of the present invention described above. ‘2’, the number of SDA 2 that is the first sub data area of session 2, or ‘N’, the number of SDA N that is the last sub data area of session 2, is recorded in the head of the record map shown in FIG. 4, as session information on the open status in which recording data is permitted.

According to the second embodiment of the present invention to record session status information, in the session status information of the record map entry indicating SDA 2, the value of bit 3 is recorded as ‘1’ and the value of bit 2 is recorded as ‘2’. In the session status information of the record map entry corresponding to SDA 1 that is the first sub data area of the session 1 in a closed status, the value of bit 3 is recorded as ‘1’ and the value of bit 2 is recorded as ‘1’.

As described above, by recording session status information indicating whether data recording is permitted or prohibited in each session, in an information storage medium, the medium may be used more efficiently. For example, a data area of a write-once information storage medium is divided into sessions 1 through 3, as shown in FIG. 7, and when the medium is finalizedto record a final file system, session 1 is closed to prevent data recording, sessions 2 and 3 are opened, and data is recorded. If a command to finalize the medium is sent by a drive or a host, session 1 is again opened, and the final file system recorded in session 2 or 3 is again recorded in session 1.

FIG. 8 is a flowchart of the operations performed by a data recording method using multi-sessions according to an embodiment of the present invention. The information storage medium is a write-once information storage medium, a data area arranged in the information storage medium is divided into a plurality of sessions, and data is recorded.

On the information storage medium placed on a drive, session status information indicating sessions in which recording data is permitted among the plurality of sessions is recorded in operation 11. Two embodiments of methods to record session status information are described above. That is, in the first embodiment, the number of a predetermined location, for example, the first or the last sub data area, among a plurality of sub data areas included in each of the sessions in an open status in which recording data is permitted, is recorded in the header of the a record map. In the second embodiment, session status information is included and recorded in a record map entry corresponding to a predetermined location, for example, the first or the last sub data area, among a plurality of sub data areas included in each of the sessions in an open status in which recording data is permitted.

According to the session status information, data is recorded in a session in which recording data is permitted in operation 13. For example, when a data area of the write-once information storage medium is divided into sessions 1 through 3, as shown in FIG. 7, session 1 is in a closed status, the remaining sessions are in an open status in which recording data is permitted, and user data and file system information are recorded in session 2 or 3. Then, if a command to finalize the medium is sent by a drive or a host, session 1 is changed again to an open status, and the final file system recorded in session 2 or 3 is again recorded in session 1.

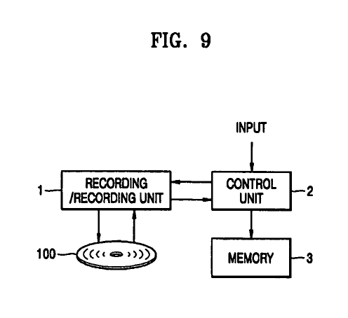

FIG. 9 is a block diagram of an information storage medium drive according to an embodiment of the present invention. The drive includes a recording and/or reading unit 1, a control unit 2, and a memory 3.

According to control of the control unit 2, the recording and/or reading unit 1 records data on, and/or reads recorded data from, the information storage medium 100 according to an embodiment of the present invention. The information storage medium 100 is a write-once information storage medium, data arranged in the information storage medium is divided into a plurality of sessions, and data is recorded.

The control unit 2 controls the recording and/or reading unit 1 such that session status information according to an embodiment of the present invention as described above is generated, and then is recorded in a predetermined area of the information storage medium 100.

As methods for recording session status information, there are two embodiments as described above.

Furthermore, the control unit 2 controls the recording/reading unit 1 such that data is recorded in a session in which recording data is permitted, according to session status information, as in step 13 shown in FIG. 8.

As described above, according to the present invention, when data is recorded on an information storage medium by using a multi-session method, a data recording area may be used more efficiently.

Although a few embodiments of the present invention have been shown and described, it would be appreciated by those skilled in the art that changes may be made in these embodiments without departing from the principles and spirit of the invention, the scope of which is defined in the claims and their equivalents.

1. A method to record data using multi-sessions, by which a data area arranged on an information storage medium is divided into a plurality of sessions and data is recorded, the data recording method comprising:
recording session status information indicating a session, among the plurality of sessions, in which recording data is permitted; and
recording data in the session in which recording data is permitted, according to the session status information.

2. The method of claim 1, wherein, in recording the session status information, an identification number of a sub data area at a predetermined location, among a plurality of sub data areas included in the session in which recording data is permitted, is recorded on the information storage medium as session status information.

3. The method of claim 1, wherein, in recording the session status information, the session status information is included in a record map including data recording status information of the data area, and is recorded.

4. The method of claim 3, wherein the record map includes head information and a plurality of record map entries, and wherein each session includes at least one sub data area, each of the record map entries includes location information and recording status information of the at least one sub data area among the plurality of sub data areas included in the data area.

5. The method of claim 4, wherein, in recording the session status information, the session status information is included in a record map entry corresponding to a sub data area of a predetermined location, among the plurality of sub data areas included in the session in which recording data is permitted, and is recorded.

6. The method of claim 1, wherein the information storage medium is a write-once information storage medium.

7. An information storage medium on which data is recorded according to a multi-session method by which a data area is divided into a plurality of sessions and data is recorded, comprising:
a first information storage unit having information recorded thereon indicating a location of each session of the plurality of sessions; and
a second information storage unit having session status information recorded thereon indicating a session, among the plurality of sessions, in which recording data is permitted.

8. The information storage medium of claim 7, wherein the session status information is the identification number of a sub data area at a predetermined location, among the plurality of sub data areas included in the session in which recording data is permitted.

9. The information storage medium of claim 7, wherein the session status information is included in a record map including data recording status information of the data area.

10. The information storage medium of claim 9, wherein the record map includes head information and a plurality of record map entries, and wherein each session includes at least one sub data area, the record map entries include location information and recording status information of the at least one sub data area among the plurality of sub data areas included in the data area.

11. The information storage medium of claim 10, wherein the session status information is included in a record map entry corresponding to a sub data area of a predetermined location, among the plurality of sub data areas included in the session in which recording data is permitted.

12. The information storage medium of claim 7, wherein the information storage medium is a write-once information storage medium.

13. A drive apparatus of an information storage medium in which a data area is divided into a plurality of sessions and data is recorded, comprising:
a recording and/or reading unit which records data on, and/or reads recorded data from, the information storage medium;
a control unit which controls the recording and/or reading unit such that session status information indicating a session, among the plurality of sessions, in which recording data is permitted, is recorded on the information storage medium, and data is recorded in a session in which recording data is permitted, according to the session status information and
a memory, coupled to the control unit, to store predetermined information.

14. The apparatus of claim 13, wherein the control unit controls the recording and/or reading unit such that an identification number of a sub data area at a predetermined location, among the plurality of sub data areas included in the session in which recording data is permitted, is recorded on the information storage medium as session status information.

15. The apparatus of claim 13, wherein the control unit controls the recording and/or reading unit such that the session status information is included in a record map including data recording status information of the data area, and is recorded.

16. The apparatus of claim 15, wherein the record map includes head information and a plurality of record map entries, and wherein each of the sessions includes at least one sub data area, each of the record map entries includes location information and recording status information of the at least one sub data area among the plurality of sub data areas included in the data area.

17. The apparatus of claim 16, wherein the control unit controls the recording and/or reading unit such that the session status information is included in a record map entry corresponding to a sub data area of a predetermined location, among the plurality of sub data areas included in sessions in which recording data is permitted, and is recorded.

18. The apparatus of claim 13, wherein the information storage medium is a write-once information storage medium.

19. A write-once disc having a data area divided into a plurality of sessions, comprising:
an inner area; and
a first spare data area, located proximate to the inner area, arranged to be used to record data recorded in a user data area when a defect occurs in the user data area,
wherein recording session status information recorded on the write-once disc indicates a session, among a plurality of sessions, in which recording data is permitted.

20. The write-once disc of claim 19, wherein the write-only disc is one of:
a single-recording-layer write-once disc; and
a double-recording-layer write-once disc.

21. The write-once disc of claim 20, wherein a structure of a recording layer of the single-recording-layer write-once disc or of each recording layer of the double-recording-layer write once disc further comprises;
a user data area, proximate to the first data area;
a last spare data area; and
an outer area proximate to the last spare data area.

23. The write-once disc of claim 21, wherein, the inner area comprises:
a plurality of disc management areas to manage defects;
a recording condition test area; and
a temporary disc management area.

24. The write-once disk of claim 22, wherein each outer area comprises a plurality of disc management areas to manage defects.

25. The write-once disk of claim 24, wherein the inner area comprises:
a temporary disc management structure information to manage, temporarily, a defect that occurs when the write-once disc is used, and to provide information to manage, temporarily, the write-once disc

26. The write-once disk of claim 25, wherein the temporary disc management structure information comprises:
a temporary disc definition list; and
a temporary disc definition structure.

27. The write-once disk of claim 26, wherein the temporary disc definition list comprises information indicating a location where a defect occurs and a location of a replacement spare area.

28. The write-once disk of claim 26, wherein the temporary disc definition structure comprises:
information indicating a location where the temporary disc definition list is recorded; information indicating a location and size of a spare area allocated when the write-once disc is initialized;
write prevention information;
information on a location and size of the temporary disc management area allocated to a data area; and
a last recorded address of the user data area.

29. The write-once disk of claim 26, wherein the temporary disc management area is selectably allocated to a data area when initialization to use the write-once disk is performed.

30. The write-once disk of claim 26, wherein, when the write-once is initialized, whether spare areas are allocated to a data area and the size of the spare areas are determined.

31. The write-once disk of claim 26, wherein, when the write-once disc is finalized, final disc defect information and other temporary disc management area information are copied into a disk management area.

32. The write-once disk of claim 26, wherein the temporary disc definition structure comprises a record map having information indicating a data recording status of each data area.

33. The write-once disk of claim 32, wherein the record map comprises:
head information; and
a plurality of record map entries.

34. The write-once disk of claim 33, wherein each record map entry indicates a data recording status of a sub data area among a plurality of sub data areas included in the data area.

35. The write-once disk of claim 19, wherein, when data is recorded on the write-once disk, session status information indicating whether each session is in a closed status, in which data recording is prohibited, or in an open status, in which recording data is permitted, is recorded.

36. The write-once disk of claim 35, wherein a number of a predetermined location of a sub data area, among a plurality of sub data areas included in each of the sessions in an open status in which recording data is permitted, is recorded in a header of a record map.

37. The write-once disk of claim 35, wherein session status information is included and recorded in a record map entry corresponding to a predetermined location of a sub data area, among a plurality of sub data areas included in each of the sessions in an open status in which recording data is permitted.
